(19) United States
(12) Patent Application Publication
(10) Pub. No.: US 2013/0139072 A1
(43) Pub. Date: May 30, 2013

(54) EXECUTING A COMPOSITED APPLICATION

(71) Applicants: Akhilesh Kaza, Sammamish, WA (US); Ashraf Ayman Michail, Redmond, WA (US); Paul Lawrence Bleisch, Sammamish, WA (US); Istvan Cseri, Seattle, WA (US); Alan Chun Tung Liu, Redmond, WA (US)

(72) Inventors: Akhilesh Kaza, Sammamish, WA (US); Ashraf Ayman Michail, Redmond, WA (US); Paul Lawrence Bleisch, Sammamish, WA (US); Istvan Cseri, Seattle, WA (US); Alan Chun Tung Liu, Redmond, WA (US)

(73) Assignee: MICROSOFT CORPORATION, Redmond, WA (US)

(21) Appl. No.: 13/305,333

(22) Filed: Nov. 28, 2011

(51) Int. Cl. G06F 3/01; G06F 3/048

(52) U.S. Cl. 715/760; 715/764; 715/765

(57) ABSTRACT

The present invention extends to methods, systems, and computer program products for enabling the development and execution of applications that employ a composited application model. A composited application includes components that are to be executed in different runtimes. Accordingly, an application developer can leverage different runtimes within a single application. A managing runtime is used to manage the various runtimes used by a composited application. The managing runtime performs input redirection to route user input to the appropriate runtime and output compositing to composite each runtime's user interface components into a single seamless scene.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

When creating an application, a developer has the option of choosing a particular runtime in which he desires the application to run. For example, a developer can choose to write an application in Java if he desires the application to run within a Java Virtual Machine, in any of the .NET languages if he desires the application to run in any of the various runtimes provided by Microsoft (e.g. Silverlight, XNA), or in Action Script if he desires the application to run in Adobe's Flash Player.

Each runtime and its supported programming languages have its advantages and drawbacks that the developer must consider in deciding which to use for a given application. Accordingly, a developer often has to develop an application in a programming language or for a runtime that meets certain requirements or provides certain benefits while at the same time lacking desired capabilities that another programming language or runtime may provide.

### BRIEF SUMMARY

The present invention extends to methods, systems, and computer program products for executing a composited application. A composited application includes components that are to be executed in different runtimes. Accordingly, an application developer can leverage different runtimes within a single application.

In one embodiment, an application is executed. The application includes a plurality of portions of executable code that each pertain to a different runtime. Executing the application includes presenting a user interface for the application. At least two of the plurality of runtimes each executes the corresponding portion of executable code to generate a different portion of the user interface. User input is received at one of the different portions of the user interface. The user input is delivered to a managing runtime. The managing runtime indentifies a runtime from among the plurality of different runtimes that is to receive the user input. Then, the managing runtime routes the user input to the identified runtime.

In another embodiment, an application is executed. The application includes a plurality of portions of executable code that each pertain to a different runtime. Executing the application includes presenting a user interface for the application. At least two of the plurality of runtimes each executes the corresponding portion of executable code to generate a different portion of the user interface. A modification to a first portion of the user interface is detected. The first portion of the user interface corresponds to a first runtime of the plurality of runtimes. The managing runtime determines that a second portion of the user interface is to be modified based on the modification to the first portion of the user interface. The second portion of the user interface corresponds to a second runtime of the plurality of runtimes. The managing runtime then sends a notification to the second runtime to indicate that the second portion of the user interface is to be modified in accordance with the modification to the first portion of the user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates creating a composited application package.

FIG. 2 illustrates an example computer architecture that facilitates creating a composited application.

FIG. 3 illustrates an example computer architecture that facilitates input redirection and output compositing when a composited application is executed.

FIG. 4 illustrates an example user interface of a composited application.

FIG. 5 illustrates another example user interface of a composited application.

FIG. 6 illustrates a flow chart of an example method for appropriately redirecting user input received at a user interface of a composited application.

FIG. 7 illustrates a flow chart of an example method for performing runtime arbitration during execution of a composited application.

### DETAILED DESCRIPTION

The present invention extends to methods, systems, and computer program products for executing a composited application. A composited application includes components that are to be executed in different runtimes. Accordingly, an application developer can leverage different runtimes within a single application.

In one embodiment, an application is executed. The application includes a plurality of portions of executable code that each pertain to a different runtime. Executing the application includes presenting a user interface for the application. At least two of the plurality of runtimes each executes the corresponding portion of executable code to generate a different portion of the user interface. User input is received at one of the different portions of the user interface. The user input is delivered to a managing runtime. The managing runtime indentifies a runtime from among the plurality of different runtimes that is to receive the user input. Then, the managing runtime routes the user input to the identified runtime.

In another embodiment, an application is executed. The application includes a plurality of portions of executable code that each pertain to a different runtime. Executing the application includes presenting a user interface for the application. At least two of the plurality of runtimes each executes the corresponding portion of executable code to generate a different portion of the user interface. A modification to a first portion of the user interface is detected. The first portion of the user interface corresponds to a first runtime of the plurality of runtimes. The managing runtime determines that a second portion of the user interface is to be modified based on the modification to the first portion of the user interface. The second portion of the user interface corresponds to a second runtime of the plurality of runtimes. The managing runtime then sends a notification to the second runtime to indicate that the second portion of the user interface is to be modified in accordance with the modification to the first portion of the user interface.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Within this description and the following claims, a composited application is defined as an application that includes components that execute on different runtimes. For example, a composited application can include an HTML component that is executed by an HTML runtime, an XNA component that is executed by an XNA runtime, and a Silverlight component that is executed by a Silverlight runtime.

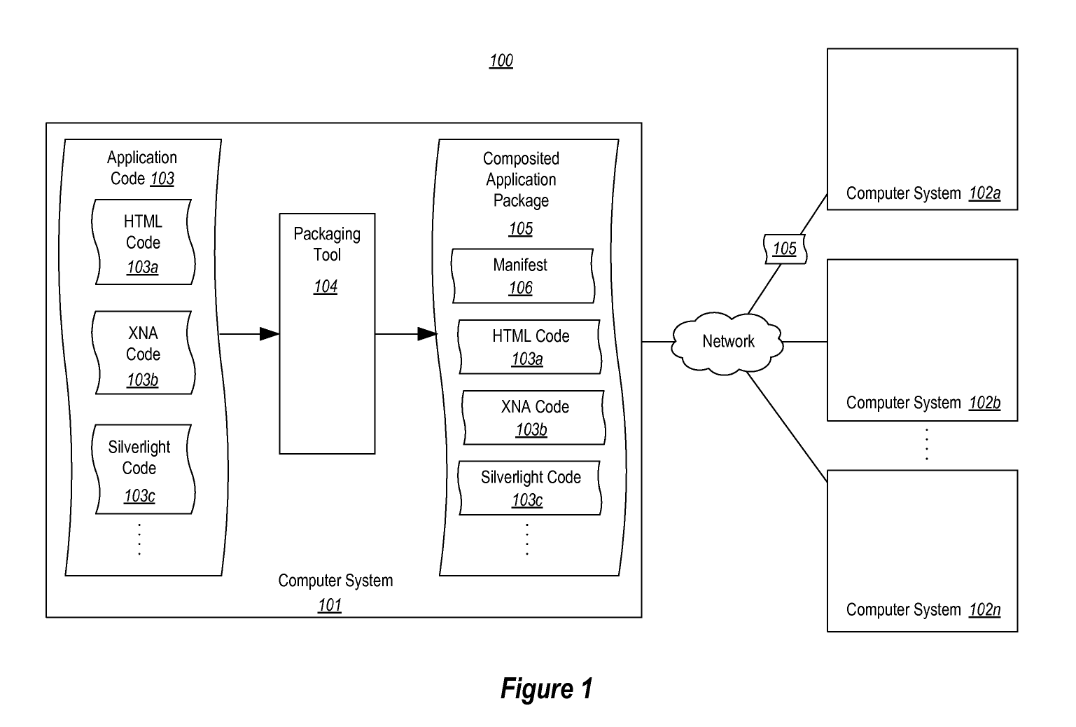

FIG. 1 illustrates an example computer architecture 100 that facilitates creating a composited application package. Referring to FIG. 1, computer architecture 100 includes computer system 101 and any number of other computer systems 102a-102n. Computer system 101 and computer systems 102a-102n can be connected to one another over (or as part of) a network, such as, for example, a Local Area Network (“LAN”), a Wide Area Network (“WAN”), and even the Internet. Accordingly, computer system 101 can communicate with the one or more other computer systems by creating message related data and exchanging message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Computer system 101 includes packaging tool 104 for creating composited application packages from application code. For example, packaging tool 104 can receive application code 103 and convert application code 103 into composited application package 105. Composited application package 105 includes code from various different programming languages and/or technologies. For example, application code 103 includes HTML code 103a, XNA code 103b, and Silverlight code 103c. Packaging tool 104 combines each of these code portions into composited application package 105.

As indicated by the ellipsis in FIG. 1, application code 103 can also include application code of other types such as, for example, XAML code, C++ code, Java code, C# code, etc. Thus, the invention is not limited to any particular set of programming languages or technologies, but extends to a variety of programming languages and technologies that can be used to create an application.

Packaging tool 104 also creates a manifest 106 that is stored within composited application package 105. Manifest 106 defines the types of code (e.g. HTML code 103a, XNA code 103b, and Silverlight code 103c) as well as any dependencies the code has. For example, if XNA code 103b is dependent on a specific component provided by the XNA framework, manifest 106 can indicate this dependency. The role of manifest 106 is further described below. As depicted in FIG. 1, composited application package 105 is sent to computer system 102a.

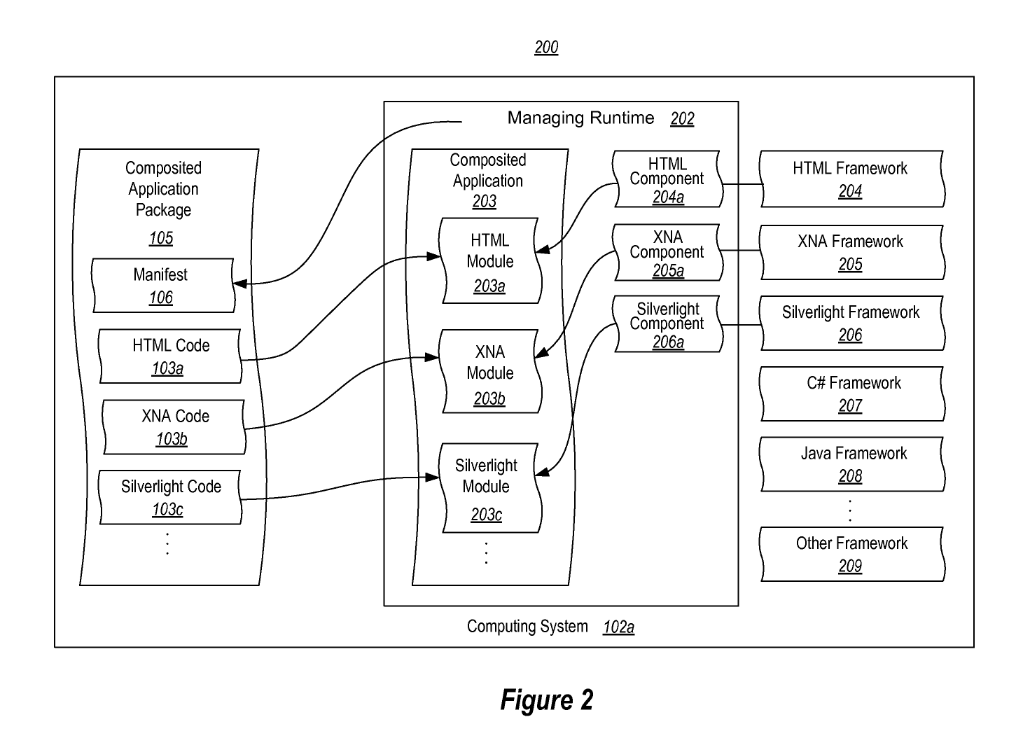

FIG. 2 illustrates an example computer architecture 200 that facilitates creating a composited application. Computer architecture 200 includes computer system 102a on which managing runtime 202 is hosted. Computer architecture 200 can also include any number of other computer systems (not shown) that are connected to computer system 102a.

Computer system 102a receives composited application package 105. Although FIGS. 1 and 2 show composited application package 105 being sent from computer system 101 to computer system 102a, composited application package 105 can be created on one computer and then transmitted to any other computer system having managing runtime 202 for execution.

Computer system 102a also includes various frameworks. For example, FIG. 2 shows that computer system 102a includes HTML framework 204, XNA framework 205, Silverlight framework 206, C++ framework 207, Java Framework 208, and any other frameworks such as XAML framework 209. These frameworks comprise necessary components for executing application code written in the corresponding programming language or for the corresponding technology. For example, Silverlight framework 206 includes necessary components to execute an application portion coded for the Silverlight framework, such as Silverlight code 103c.

When it receives a composited application package for execution, managing runtime 202 accesses the manifest within the composited application package and determines all necessary components for execution of application code within the composited application package. This can include managing runtime 202 determining which components of which frameworks are required for execution of the application code. For example, when managing runtime 202 receives composited application package 105, it can access manifest 106 to determine that composited application package 105 includes HTML code 103a, XNA code 103b, and Silverlight code 103c. Managing runtime 202 can also determine from manifest 106 which components of which frameworks are required for proper execution of the application code.

As shown in FIG. 2, managing runtime 202 determines from manifest 106 that HTML component 204a, XNA component 205a, and Silverlight component 206a are required for execution of HTML code 103a, XNA code 103b, and Silverlight code 103c respectively. Of course, managing runtime 202 can also determine that components from other frameworks are required based on manifest 106. An example of a component of a framework includes a dynamically linked library (DLL) from the framework. For example, Silverlight component 206a can be a DLL containing the implementation of classes that Silverlight code 103c uses (e.g. by making API calls).

Although FIG. 2 shows that the frameworks are stored locally on computer system 102a, a portion or all of a framework can also be stored remotely and accessed as necessary by managing runtime 202.

To execute the application code in composited application package 105, managing runtime 202 creates composited application 203. Creating composited application 203 can include accessing (or downloading if stored remotely) and bootstrapping all necessary components from any of frameworks 204-209. For example, managing runtime 202 can combine HTML code 103a, XNA code 103b, and Silverlight code 103c with HTML component 204a, XNA component 205a, and Silverlight component 206a to create HTML module 203a, XNA module 203b, and Silverlight module 203c respectively. Additionally, any other components of any other framework specified in manifest 106 can also be including in composited application 203. Composited application 203 is therefore a single application having application code and framework components for execution on different runtimes.

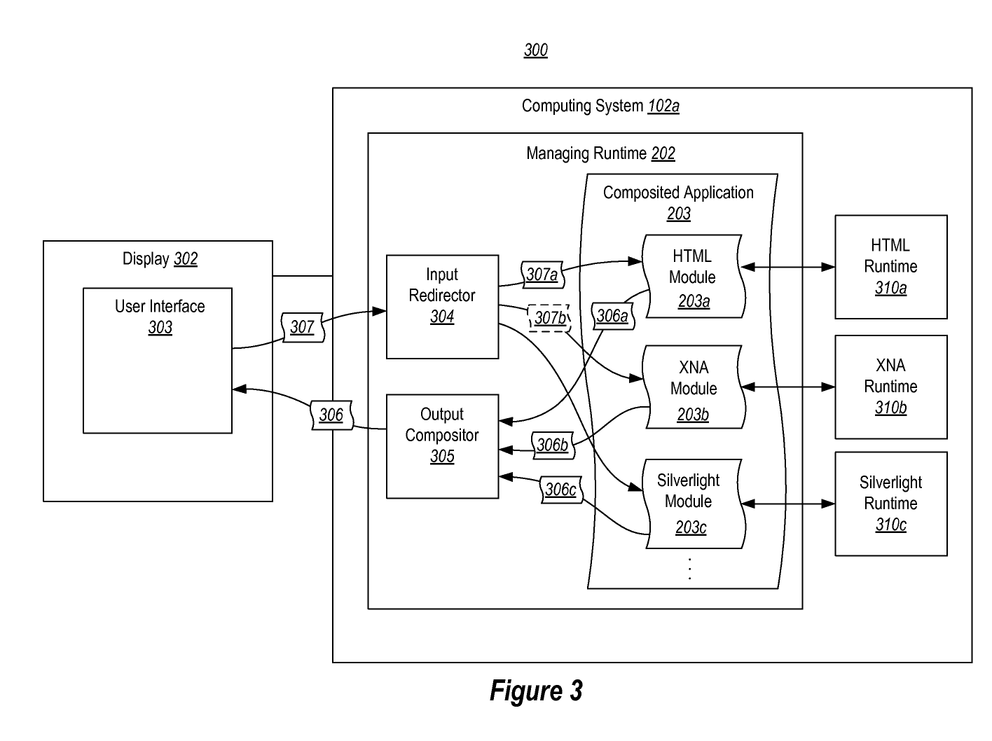

Because composited application is comprised of various different technologies that are executed by different runtimes, managing runtime 202 manages input to and output from the various different runtimes while they execute the corresponding code within composited application 203. FIG. 3 shows an example computer architecture 300 that illustrates how managing runtime 202 facilitates input redirection and output compositing when a composited application is executed.

Computer architecture 300 includes computer system 102a which hosts managing runtime 202. Although computer system 102a is depicted in FIG. 3, any computer that hosts managing runtime 202 can be used in the manner described below. For example, computer system 102a can be used to create composited application 203, while another computer system is used to execute composited application 203.

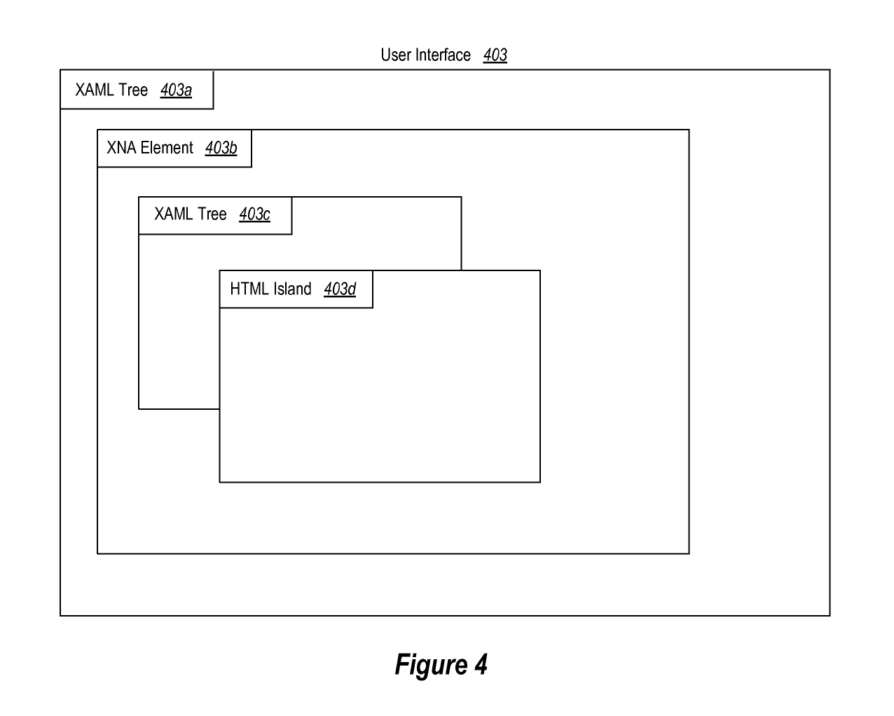

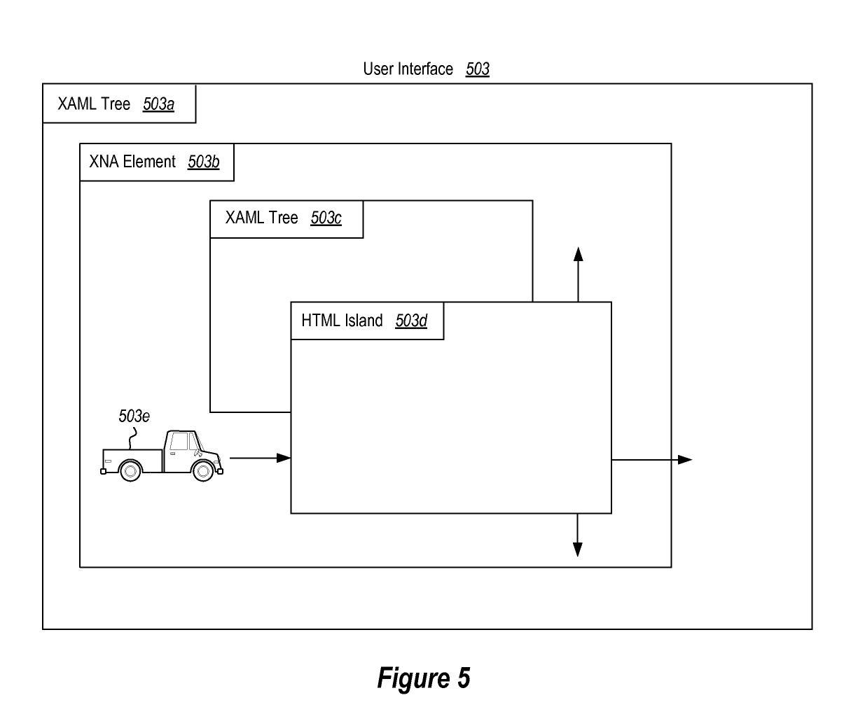

Computer system 102a includes display 302 on which user interface 303 of composited application 203 is displayed. User interface 303 is comprised of various portions including portions generated by each of the different runtimes used to execute composited application 203 as is shown in FIGS. 4 and 5 and described below. In other words, some or all of the runtimes used to execute composited application 203 generate user interface components (e.g. scenes) for display within user interface 303. Managing runtime 202 enables the user interface components from each of the runtimes to be composited into a single seamless scene. The fact that this single seamless scene is generated from multiple different runtimes will be transparent to the user. In other words, user interface 303 will appear as if it is being generated by a single runtime.

As shown in FIG. 3, managing runtime 202 includes input redirector 304 and output compositor 305. Output compositor 305 receives user interface components 306a-306c from HTML runtime 310a, XNA runtime 310b, and Silverlight runtime 310c respectively. Although FIG. 3 shows user interface components being received from each runtime, at different times during the display of user interface 303, user interface components may be received from less than all of the runtimes. Output compositor 305 composites user interface components 306a-306c into a single output 306 for display within user interface 303. User interface components 306a-306c can comprise instructions for rendering a user interface element or control, a background, or other visible feature of user interface 303, instructions defining the structure of user interface 303, or any other instructions for displaying user interface 303 on display 302.

Output 306 can be configured in any appropriate format for display on display 302. In other words, output compositor 305 generates output 306 from user interface components 306a-306c in an appropriate format for display on display 302. Output compositor 305 can receive additional user interface components from any of the runtimes at periodic intervals and generate updates to output 306 to modify user interface 303. In one embodiment, output 306 comprises Direct3D textures.

While user interface 303 is displayed, a user can provide input to user interface 303 in any way known in the art. For example, a user can click on a user interface control, hit a key on the keyboard, or click the mouse with the cursor over a portion of user interface 303. Because user interface 303 includes portions generated by various different runtimes, when user input is received, managing runtime 202 employs input redirector 304 to route the input to the appropriate runtime.

For example, if user input selects a user interface control that was generated from HTML module 203a by HTML runtime 310a, input redirector 304 determines that the user input should be routed to HTML runtime 310a. In contrast, if user input provides a command to a portion of user interface 303 corresponding to an XNA cube generated from XNA module 203b by XNA runtime 310b, input redirector 304 determines that the user input should be routed to XNA runtime 310b.

For example, FIG. 3 shows that input 307 is received at user interface 303 and that input redirector 304 routes the input 307a to HTML runtime 310a. The code within HTML module 203a being executed by HTML runtime 310a defines how to respond to input 307a. In some embodiments, input 307a is the same as input 307. In other words, input 307 may only pertain to HTML runtime 310a. In other cases, input 307 can pertain to multiple runtimes, in which case, input redirector 304 can route the appropriate portions to the corresponding runtime. FIG. 3 illustrates this case by showing input 307 being divided into two portions 307a and 307b that are routed to HTML runtime 310a and XNA runtime 310b respectively.

Input redirector 304 can determine to which runtime input applies by consulting output compositor 305. For example when it generates output 306, output compositor 305 can maintain an indication of which portions of user interface 303 correspond to which runtime. These indications can be communicated to input redirector 304, such as when input redirector 304 receives input, or each time a new output 306 is generated. Input redirector 304 accesses the indications to determine which runtime the input is to be routed to. For example, the indications may identify the coordinates of the portions of user interface 303 that were generated by each runtime.

In other embodiments, managing runtime 202 can send user input to each runtime until a runtime indicates that it has the ability to respond to the user input. For example, managing runtime 202 can send user input to HTML runtime 310a asking whether HTML runtime 310a can respond to the user input, and then to XNA runtime 310b, and so on until one of the runtimes responds to the input.

Managing runtime 202 can also determine that the user input pertains to itself. For example, a managing runtime 202 can generate a portion of user interface 303 that is selected. Additionally, managing runtime 202 can process user input even if the user input is also processed by another runtime. For example, user input can affect HTML runtime 310a and at the same time affect a portion of user interface managed by managing runtime 202. In essence, managing runtime 202 ensures that when user input is received, each affected runtime is made aware of the user input to be able to respond accordingly.

Managing runtime 202 can comprise a runtime of any of a number of different types. In one embodiment, managing runtime 202 is a XAML runtime. In other embodiments, managing runtime 202 can be one of an HTML runtime, an XNA runtime, a Silverlight runtime, or any other runtime. In other words, a particular runtime can be used as the managing runtime 202 or can be a managed runtime.

FIG. 4 illustrates the structure of an exemplary user interface 403 that can be generated during execution of composited application 203. As shown, user interface 403 is structured as a XAML tree 403a having an XNA element 403b. XNA element 403b further includes a XAML tree 403c and an HTML island 403d. As stated above, output compositor 305 composites user interface components from various runtimes into a single seamless scene. In other words, from the user's perspective, it would appear as if each portion of user interface 403 were generated from a single runtime.

In addition to redirecting user input, managing runtime 202 can also perform runtime arbitration between the different runtimes of a composited application. FIG. 5 illustrates an exemplary user interface 503 that is similar to user interface 403. FIG. 5 shows an example situation in which managed runtime 202 performs runtime arbitration. As shown, user interface 503 is configured as a XAML tree 503a having an XNA element 503b. XNA element 503b further includes a XAML tree 503c and an HTML island 503d. In other words, HTML island 503d and XAML tree 503c are layered inside XNA element 503b which is layered inside XAML tree 503a.

XNA element 503b defines an image 503e of a truck traveling towards the right within user interface 503. While image 503e is outside the extents of HTML island 503d, the animation of image 503e does not affect HTML island 503d (i.e. the rendered display of HTML components within the area of the scene encompassed by HTML island 503d). However, once the animation of image 503e reaches the edge of HTML island 503d, the continued animation of image 503e affects HTML island 503d. For example, if no changes were made to HTML island 503d, the animation of image 503e could result in image 503e having an intended position in the same location as a control, such as a button or textbox, within HTML island 503d thus causing ambiguity in how user interface 503 is to be displayed.

To manage such interactions between portions of user interface 503 from different runtimes, managing runtime 202 performs runtime arbitration. For example, managing runtime 202 can coordinate the continued animation of image 503e within XNA element 503b with respect to HTML island 503d. For example, managing runtime 202 can detect the potential conflict between XNA element 503b and HTML island 503d and respond appropriately.

In some scenarios, managing runtime 202 can perform the arbitration itself such as by instructing output compositor 305 to move XNA element 503b and/or HTML island 503d within user interface 503. In such scenarios, managing runtime 202 can notify the affected runtimes accordingly. In other scenarios, managing runtime 202 can provide input to HTML runtime 310a and/or to XNA runtime 310b (and potentially other runtimes of composited application 203) to inform HTML runtime 310a and/or XNA runtime 310b of the conflict. In such scenarios, HTML runtime 310a and/or XNA runtime 310b (and potentially other runtimes of composited application 203) can generate updated user interface components to provide to output compositor 305. Output compositor 305 can then generate output 306 for rendering user interface 503 accordingly.

As shown in FIG. 5, runtime arbitration can result in a portion of user interface 503 being moved to accommodate changes in another portion of user interface 503. As shown, HTML island 503d can be moved to enable the animation of image 503e to continue without conflicting with HTML island 503d. Although FIG. 5 shows HTML island 503d being moved, runtime arbitration can also result in the animation of image 503e being reversed, stopped, or otherwise altered (such as superimposing image 503e over HTML island 503d) so as to not conflict with HTML island 503d.

Runtime arbitration is not limited to scenarios where the movement of elements of one portion of the user interface affects another portion of the user interface. For example, runtime arbitration can be required when input to one portion of the user interface will require changes to the overall user interface or to another portion of the user interface. Accordingly, runtime arbitration can be used any time execution of code within one runtime affects code within another runtime whether the code relates to the display of the user interface or to another function.

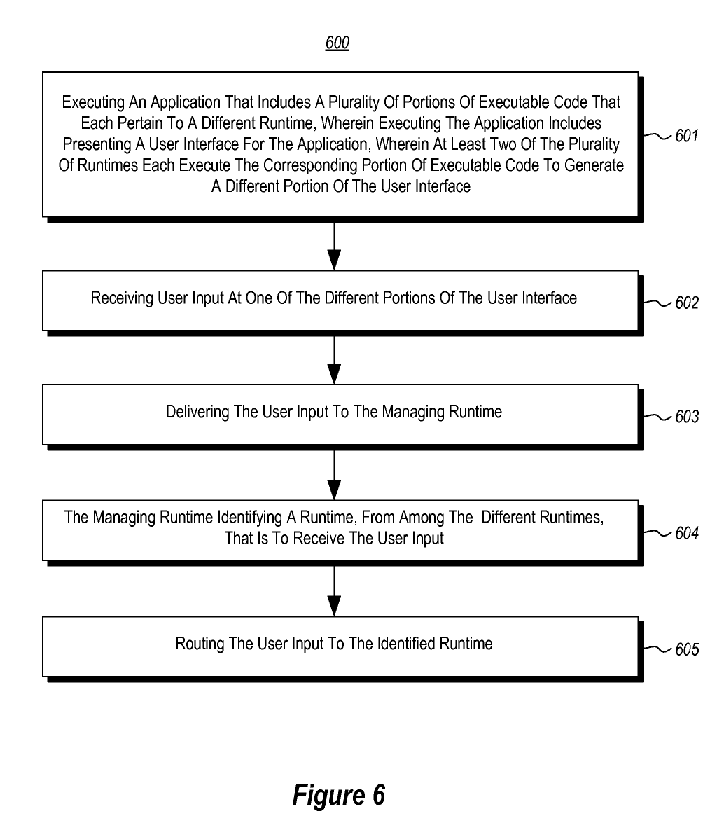

FIG. 6 illustrates a flow chart of an example method 600 for redirecting user input to an appropriate runtime when user input is received at a user interface of a composited application. Method 600 will be described with respect to the components and data illustrated in FIGS. 2-4.

Method 600 includes an act 601 of executing executable code for an application that includes a plurality of portions of executable code that each pertain to a different runtime, wherein executing the application includes presenting a user interface for the application, wherein at least two of the plurality of runtimes each executes the corresponding portion of executable code to generate a different portion of the user interface. For example, composited application 203 can be executed within managing runtime 202. Composited application 203 can include multiple modules for execution within different runtimes such as HTML runtime 310a, XNA runtime 310b, and Silverlight runtime 310c for executing HTML module 203a, XNA module 203b, and Silverlight module 203c respectively to generate user interface components 306a-306c respectively for inclusion in user interface 303.

Method 600 includes an act 602 of receiving user input at one of the different portions of the user interface. For example, user input can be received within user interface 403 at any of portions 403a-403d.

Method 600 includes an act 603 of delivering the user input to the managing runtime. For example, the user input received at user interface 403 can be delivered to input redirector 304 within managing runtime 202.

Method 600 includes an act 604 of the managing runtime identifying a runtime from among the different runtimes that is to receive the user input. For example, managing runtime 202 can identify which runtime from among managing runtime 202, HTML runtime 310a, XNA runtime 310b, and Silverlight runtime 310c is to receive the user input.

Identifying which runtime is to receive the user input can include determining where on user interface 403 the user input was received. For example, a mouse click can be received within HTML island 404d, and managing runtime 202 can determine that the mouse click occurred within HTML island 404d by accessing an indication that the area of user interface 403 in which the mouse click occurred displays user interface components that were generated by HTML runtime 310a.

Identifying which runtime is to receive the user input can also include consecutively passing the user input to each runtime until a runtime processes the input. For example, each runtime can be configured to identify and process user input that is intended for the particular runtime.

Method 600 includes an act 605 of routing the user input to the identified runtime. For example, managing runtime 202 can route the user input to HTML runtime 310a to allow HTML runtime 310a to appropriately handle the input (e.g. by executing the appropriate code within HTML module 203a). Managing runtime 202 can also identify more than one runtime that is to receive the user input and route the user input, or a portion of the user input, to each runtime.

Method 600 can also include updating user interface 403 after the identified runtime processes the user input. For example, HTML runtime 310a can process the user input and update a component (e.g. a user interface control) being displayed within HTML island 404d. Managing runtime 202 can composite output from HTML runtime 310a as well as output from any of the other runtimes into a single output for generating an updated version of user interface 403.

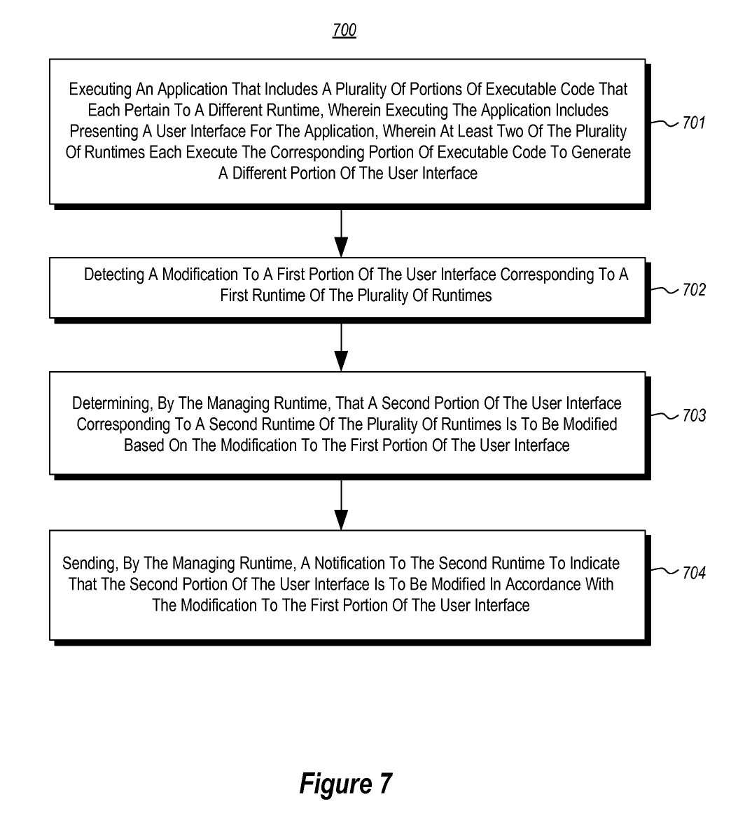

FIG. 7 illustrates a flow chart of an example method 700 for performing runtime arbitration during execution of a composited application. Method 700 will be described with respect to the components and data illustrated in FIGS. 2, 3, and 5.

Method 700 includes an act 701 of executing an application that includes a plurality of portions of executable code that each pertain to a different runtime, wherein executing the application includes presenting a user interface for the application, wherein at least two of the plurality of runtimes each execute the corresponding portion of executable code to generate a different portion of the user interface. For example, composited application 203 can be executed within managing runtime 202. Composited application 203 can include modules for execution within multiple runtimes such as HTML runtime 310a, XNA runtime 310b, and Silverlight runtime 310c for executing HTML module 203a, XNA module 203b, and Silverlight module 203c respectively to generate user interface components 306a-306c respectively for inclusion in user interface 303.

Method 700 includes an act 702 of detecting a modification to a first portion of the user interface corresponding to a first runtime of the plurality of runtimes. For example, image 503e within XNA element 503b can be moved within the portion of user interface 503 defined by XNA element 503b.

Method 700 includes an act 703 of determining, by the managing runtime, that a second portion of the user interface corresponding to a second runtime of the plurality of runtimes is to be modified based on the modification to the first portion of the user interface. For example, managing runtime 202 can determine that the movement of image 503e within XNA element 503b requires modification to HTML island 503d.

Method 700 includes an act 704 of sending, by the managing runtime, a notification to the second runtime to indicate that the second portion of the user interface is to be modified in accordance with the modification to the first portion of the user interface. For example, managing runtime 202 can notify HTML runtime 310a of the movement of image 503e within XNA element 503b to enable HTML runtime 310a to modify HTML island 504d in a manner consistent with the movement of image 503e within XNA element 503b.

The second runtime can modify the second portion by generating updated rendering instruction (or other information for describing the second portion) which can be composited with rendering instructions from some or all of the other runtimes into a single output for generating an updated version of user interface 503.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, the computer system having a plurality of runtimes, the plurality of runtimes including a managing runtime and one or more other runtimes, each runtime configured to execute a portion of an application that includes a different portion of executable code pertaining to each runtime, a method of directing user input to a user interface of the application to the appropriate runtime from among the plurality of runtimes during execution of the application, the method comprising:
executing an application that includes a plurality of portions of executable code that each pertain to a different runtime, wherein executing the application includes presenting a user interface for the application, wherein at least two of the plurality of runtimes each executes the corresponding portion of executable code to generate a different portion of the user interface;
receiving user input at one of the different portions of the user interface;
delivering the user input to the managing runtime;
the managing runtime identifying a runtime from among the different runtimes that is to receive the user input; and
routing the user input to the identified runtime.

2. The method of claim 1, wherein the different runtimes include two or more of an HTML runtime, an XNA runtime, and a Silverlight runtime.

3. The method of claim 2, wherein the managing runtime is a XAML runtime.

4. The method of claim 3, wherein the user interface is structured as a XAML tree that contains a portion generated by at least one of: the XNA runtime, the HTML runtime, or the Silverlight runtime.

5. The method of claim 1, wherein the managing runtime includes an HTML framework, an XNA framework, or a Silverlight framework.

6. The method of claim 1, wherein the at least two of the plurality of runtimes each executing the corresponding portion of executable code to generate a different portion of the user interface comprises each of the at least two runtimes generating rendering instructions for rendering the corresponding different portion, and wherein presenting a user interface for the application comprises compositing the rendering instructions for rendering each of the corresponding different portions into a single output that defines the user interface.

7. The method of claim 1, wherein presenting a user interface for the application includes creating an indication of the location of each of the different portions of the user interface along with an identification of which runtime generated the different portion.

8. The method of claim 1, wherein the managing runtime indentifying a runtime from among the plurality of different runtimes that is to receive the user input comprises determining which runtime generated the portion of the user interface where the user input was received.

9. The method of claim 8, wherein the managing runtime identifying a runtime from among the plurality of different runtimes that is to receive the user input by determining which runtime generated the portion of the user interface where the user input was received comprises the managing runtime determining that the managing runtime generated the portion of the user interface where the user input was received.

10. The method of claim 1, wherein the managing runtime identifying a runtime from among the plurality of different runtimes that is to receive the user input comprises sending the user input to each runtime until a runtime acknowledges having the ability to respond to the user input.

11. The method of claim 1, wherein the managing runtime identifying a runtime from among the plurality of different runtimes that is to receive the user input comprises identifying two or more runtimes that are to receive the user input; and wherein routing the user input to the identified runtime comprises routing the user input to each of the two or more identified runtimes.

12. The method of claim 1, further comprising:
the identified runtime modifying the corresponding portion of the user interface; and
displaying the modified portion within the user interface.

13. At a computer system, the computer system having a plurality of runtimes, the plurality of runtimes including a managing runtime and one or more other runtimes, each runtime configured to execute a portion of an application that includes a different portion of executable code pertaining to each runtime, a method of at least two runtimes interoperating to present a user interface for an application, the method comprising:
executing an application that includes a plurality of portions of executable code that each pertain to a different runtime, wherein executing the application includes presenting a user interface for the application, wherein at least two of the plurality of runtimes each execute the corresponding portion of executable code to generate a different portion of the user interface;
detecting a modification to a first portion of the user interface corresponding to a first runtime of the plurality of runtimes;
determining, by the managing runtime, that a second portion of the user interface corresponding to a second runtime of the plurality of runtimes is to be modified based on the modification to the first portion of the user interface; and
sending, by the managing runtime, a notification to the second runtime to indicate that the second portion of the user interface is to be modified in accordance with the modification to the first portion of the user interface.

14. The method of claim 13 wherein either the first or the second runtime is the managing runtime.

15. The method of claim 13 wherein the managing runtime is a XAML runtime, and wherein the first and second runtimes are each a different runtime from among an HTML runtime, an XNA runtime, and a Silverlight Runtime.

16. The method of claim 13, wherein the at least two of the plurality of runtimes each executing the corresponding portion of executable code to generate a different portion of the user interface comprises each of the at least two runtimes generating rendering instructions for rendering the corresponding different portion, and wherein presenting a user interface for the application comprises compositing the rendering instructions for rendering each of the corresponding different portions into a single output that defines the user interface.

17. The method of claim 13 wherein the second portion of the user interface is layered within the first portion of the user interface, and wherein the modification to the first portion of the user interface comprises the movement of an element within the first portion of the user interface.

18. The method of claim 13 wherein the notification comprises one or more of:
an identification of the modification to the first portion of the user interface; or
instructions regarding how the second portion of the user interface is to be modified.

19. The method of claim 13 further comprising:
receiving, by the managing runtime, rendering instructions defining updated first and second portions from the first and second runtimes respectively; and
presenting the user interface with the updated first and second portions.

20. At a computer system, the computer system having a managing runtime comprising a XAML runtime and a plurality of managed runtimes comprising an HTML runtime, an XNA runtime, and a Silverlight runtime, each runtime configured to execute a portion of an application that includes a different portion of executable code pertaining to each runtime, a method of directing user input to a user interface of the application to the appropriate runtime from among the plurality of runtimes during execution of the application, the method comprising:
receiving an application that includes an HTML runtime, an XNA runtime, and a Silverlight runtime, the HTML, XNA, and Silverlight runtimes comprising HTML, XNA, and Silverlight code respectively that is executed by the HTML, XNA, and Silverlight runtimes respectively to each generate a portion of a user interface of the application;
executing the application including receiving, by the XAML runtime, rendering instructions from each runtime for generating a corresponding portion of the user interface of the application;
outputting, by the XAML runtime, a single output scene of the user interface, the single output scene including each of the portions generated by the HTML, XNA, and Silverlight runtimes;
receiving user input at one of the different portions of the user interface;
delivering the user input to the XAML runtime;
the XAML runtime identifying a runtime from among the different runtimes that is to receive the user input; and
routing the user input to the identified runtime.
